(19) United States
(12) Patent Application Publication
(10) Pub. No.: US 2024/0060762 A1
(43) Pub. Date: Feb. 22, 2024

(54) INSPECTION DEVICE

(71) Applicant: FUJI CORPORATION, Chiryu (JP)

(72) Inventors: Daisuke FUKUOKA, Toyota-shi (JP); Takafumi HARAGUCHI, Toyota-shi (JP)

(73) Assignee: FUJI CORPORATION, Chiryu (JP)

(21) Appl. No.: 18/260,758

(22) PCT Filed: Mar. 17, 2021
(86) PCT No.: PCT/JP2021/010812

§ 371 Date: Jul. 7, 2023

(51) Int. Cl. G01B 5/00

(52) U.S. Cl. CPC G01B 5/0004; G01B 5/0009

(57) ABSTRACT

An inspection device for performing master alignment and inspection at the same position includes a chuck configured to grip and release a workpiece, an inspection machine configured to, by bringing a contactor into contact with a processed portion of the workpiece, inspect the processed portion, a master table configured to hold a master gauge configured to perform master alignment with respect to the inspection machine, and a position replacing mechanism configured to integrally move the chuck and the master table and replace the workpiece gripped by the chuck and the master gauge held by the master table with each other at an inspection position in the inspection machine.

### TECHNICAL FIELD

An object of the present disclosure is to provide an inspection device for performing master alignment using a master gauge and inspection on a workpiece at the same position.

### BACKGROUND ART

In an automatic processing line, the processing dimensions are inspected for a workpiece that has been processed by a machine tool or the like. Patent Literature 1 below also discloses an inspection device which executes such inspection. The inspection device in Patent Literature 1 is used for determining the good or bad of the hole processing performed on the workpiece in which a large number of holes having different diameters have been processed. In such an inspection device, a reference diameter of multiple processed holes to be inspected is read before inspection. In the case of the present conventional art, a master gauge is moved from a standby position to a reference diameter measurement position by a cylinder, and a detected value obtained by protruding an electric micrometer and bringing a detector into contact with an inner diameter of the gauge is stored. Thereafter, in the inspection of the processed holes, the target electric micrometer protrudes by an operation of a rotary actuator, and the detector is inserted into the target hole by the movement in the three axial directions, so that the contact with the inner surface is performed. Then, in the calculation processing unit, a reference diameter of the hole diameter during inspection from the master table is selected, and the selected reference diameter is compared with the measured value to determine whether it is within the tolerance.

### PATENT LITERATURE

Patent Literature 1: JP-UM-A-H7-20505

### BRIEF SUMMARY

### Technical Problem

The inspection device is configured to read a reference dimension before inspection using a master gauge corresponding to the workpiece to be processed (hereinafter, referred to as “master alignment”). However, conventionally, it is necessary for the operator to install a master gauge in a chuck portion of the inspection device. Since a workpiece is sent to the chuck portion in general, the operator needs to set the master gauge every time the master alignment is performed. In this regard, the inspection device of the conventional art has a configuration in which the master gauge moves between the standby position and the reference diameter measurement position by the extension and contraction of the cylinder. However, the inspection device is intended to fix the workpiece that is sent in front of the moving head on which the electric micrometer is mounted. Although the configuration for installing a workpiece including a chuck mechanism or the like is not clear, the inspection device has a configuration where the position at which master alignment is performed by the electric micrometer is different from the position at which inspection of the workpiece is actually performed. Therefore, there is a concern that a deviation occurs between the master alignment and the inspection, resulting in a decrease in the inspection accuracy.

In order to solve the above problem, an object of the present disclosure is to provide an inspection device for performing master alignment and inspection at the same position.

### Solution to Problem

An inspection device according to an aspect of the present disclosure includes a chuck configured to grip and release a workpiece, an inspection machine configured to, by bringing a contactor into contact with a processed portion of the workpiece, inspect the processed portion, a master table configured to hold a master gauge configured to perform master alignment with respect to the inspection machine, and a position replacing mechanism configured to integrally move the chuck and the master table and replace the workpiece gripped by the chuck and the master gauge held by the master table with each other at an inspection position in the inspection machine.

### Advantageous Effects

With the above configuration, a processed workpiece is gripped by a chuck, and a processed portion with respect to the gripped processed workpiece is inspected using an inspection machine, in which a master alignment using a master gauge is performed at an inspection position in the inspection machine in advance, and when inspecting the processed portion, the position replacing mechanism integrally moves the chuck and the master table, whereby the workpiece gripped by the chuck and the master gauge held by the master table are replaced at the same inspection position in the inspection machine.

### BRIEF DESCRIPTION OF DRAWINGS

FIG. 1 is a front view illustrating a front facing twin spindle lathe in which an inspection device is used.

FIG. 2 is a side view illustrating a main body portion of the inspection device together with an autoloader.

FIG. 3 is a perspective view illustrating a main body portion of the inspection device.

FIG. 4 is a front view illustrating a main body portion of the inspection device.

FIG. 5 is a side view of the inspection device illustrating replacement of a master gauge and a workpiece.

### DESCRIPTION OF EMBODIMENTS

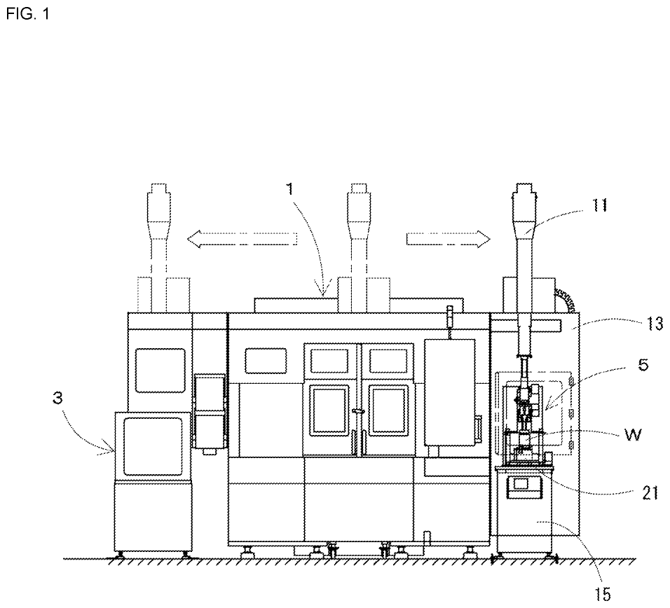

An embodiment of an inspection device according to the present disclosure will be described below with reference to the drawings. FIG. 1 is a front view illustrating a front facing twin spindle lathe in which the inspection device of the present embodiment is used. When viewed from the front, supply workpiece stocker 3 is disposed on the left side of front facing twin spindle lathe 1, and inspection device 5 is disposed on the right side of front facing twin spindle lathe 1. Front facing twin spindle lathe 1 is provided with gantry type autoloader 11 and configured to convey workpiece W from supply workpiece stocker 3 to inspection device 5.

Workpiece stocker 3 is configured such that stacked workpieces W are mounted on multiple pallets, respectively, and move in a circumferential manner on a moving table, so that the pallet on which corresponding workpiece W is mounted is sent to the delivery position. A lifting and lowering machine is provided at the transfer position, so that workpieces W are picked up one by one from the pallet by autoloader 11. Front facing twin spindle lathe 1 includes a pair of lathes that execute predetermined processing on workpiece W carried from workpiece stocker 3 into a processing chamber. The transfer between main spindle chucks in the processing chamber is also performed by autoloader 11.

Processed workpiece W is carried from front facing twin spindle lathe 1 to inspection device 5 by autoloader 11, in which the dimensions of the processed portion are inspected. In FIG. 1, the internal structure of inspection device 5 is illustrated in a state in which device cover 13 is viewed through. In inspection device 5, a device main body is configured on table 15, and processed workpiece W conveyed from autoloader 11 is transferred to chuck 21 which faces upward. Although only front facing twin spindle lathe 1 is illustrated in FIG. 1, for example, a processing line in which other working machines are arranged is configured in a factory, and processed workpiece W is picked up from inspection device 5 and conveyed to the next working machine.

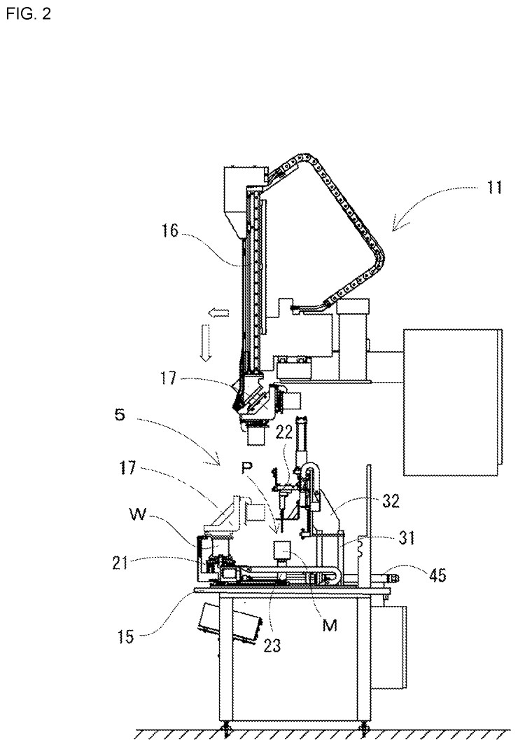

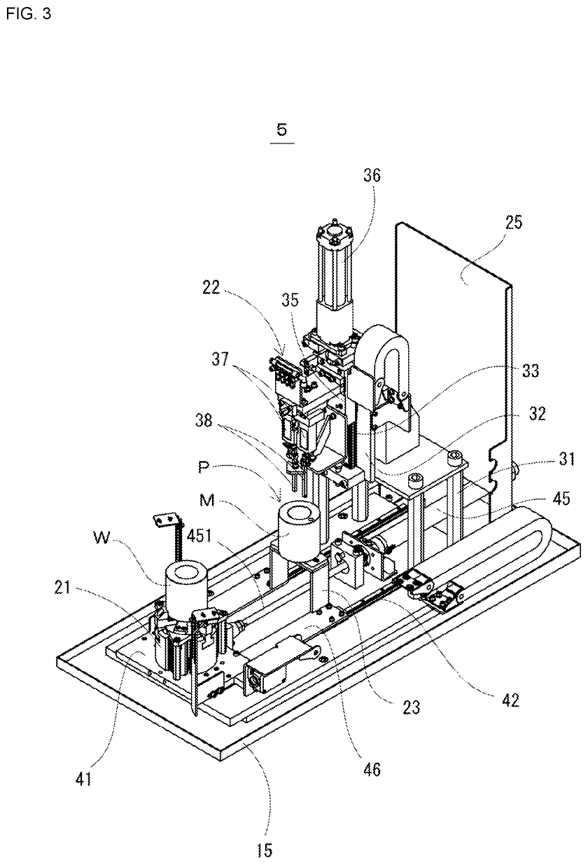

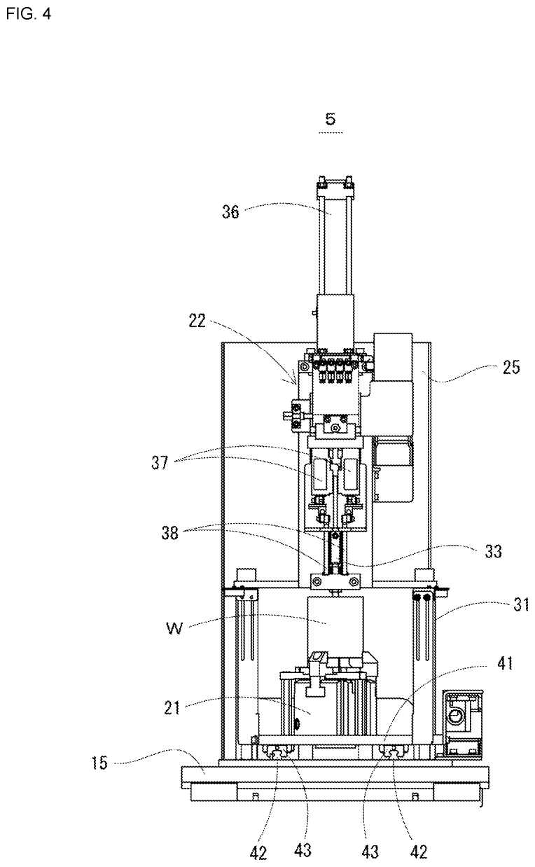

Subsequently, FIG. 2 is a side view illustrating a main body portion of inspection device 5 together with autoloader 11. FIG. 3 is a perspective view illustrating a main body portion of inspection device 5, and FIG. 4 is a front view illustrating a main body portion of inspection device 5. FIG. 3 and FIG. 4 illustrate inspection device 5 in a state in which the legs of table 15 are removed. In inspection device 5, chuck 21 that grips workpiece W and inspection machine 22 are disposed on table 15 in a front-rear direction, and master table 23 holding master gauge M for performing master alignment is disposed between chuck 21 and inspection machine 22.

Back plate 25 is erected on a rear portion of table 15, and inspection machine 22 is assembled in front of back plate 25. Bracket 32 is fixed on support column 31, and vertical guide rail 33 is provided thereon. Lifting and lowering slide 35 is slidably assembled to guide rail 33, and a piston rod of air cylinder 36 fixed to bracket 32 is coupled to lifting and lowering slide 35. Inspection machine 22 is mounted on lifting and lowering slide 35, and by air cylinder 36, which has vertical posture, performing an extension and contraction operation, it is possible to move between the illustrated standby position that is lifted and the inspection execution position that is lowered toward master gauge M.

In inspection machine 22, a pair of measuring heads 37 are provided in a left-right width direction, and contactor 38 is attached to each of measuring heads 37 facing downward. Two measuring heads 37 are attached to different brackets, respectively, and have a structure capable of independent movement in the left-right width direction so that the intervals therebetween can be changed and adjusted. The pair of measuring heads 37 is provided with pistons that pivot a pair of contactors 38 against the spring force of the spring, and is operated by the supply and exhaust of the compressed air, and is configured such that the measurement with respect to contactors 38 is performed by the air pressure control. In addition, measuring head 37 is provided with a detection sensor that detects the displacement amount of contactor 38, and is configured such that the detection signal is transmitted to a control device provided on front facing twin spindle lathe 1.

In inspection device 5, master gauge M held by master table 23 is disposed at inspection position P directly below contactors 38 so that the master alignment can be performed at all times with respect to inspection machine 22. However, when inspecting workpiece W, master gauge M needs to be moved from inspection position P. Therefore, in the present embodiment, a position replacing mechanism in which the disposition of master gauge M and workpiece W at inspection position P is replaced with each other is provided.

Chuck 21 is provided at a position distant from inspection position P so that a delivery operation of workpiece W by autoloader 11 is not obstructed by inspection machine 21. Chuck 21 is disposed on the front side with respect to inspection machine 22 positioned behind table 15. Chuck 21 is configured to grip and release workpiece W by opening and closing three chuck claws assembled radially. Chuck 21 is assembled on slide table 41 and is movable in the front-rear direction on table 15. Two guide rails 42 are horizontally fixed on the left and right sides on table 15, so that slides 43 slidably mesh therewith. Slide table 41 is fixed to the left and right slides 43, and piston rod 451 of air cylinder 45 is coupled to slide table 41.

Bracket 32 is assembled on table 15 by four support columns 31, and is disposed below inspection machine 22 such that air cylinder 45 passes between support columns 31. In air cylinder 45, a cylinder portion is fixed on table 15 so as to be parallel to guide rail 42 disposed in the front-rear direction, and piston rod 451 protrudes forward from a lower position of inspection machine 22. Inspection device 5 is configured such that when this piston rod 451 extends and contracts, table 15 moves along guide rail 42, and mounted chuck 21 is positioned at two predetermined positions in the front-rear direction.

In addition, the position replacing mechanism has an integral configuration in which master table 23 is coupled to slide table 41 so that master gauge M and workpiece W can be moved simultaneously. Specifically, slide table 41 on which chuck 21 is mounted and slide plates 46 which move according to guide rails 42 are integrally configured. Slide plate 46 has the same slide 43 as slide table 41 and is slidable along guide rail 42. Square-bracket-shaped master table 23 is fixed to left and right slide plates 46 so as to straddle air cylinder 45. Master table 23 has holding holes formed on an upper surface thereof, into which protruding portions formed on a lower surface of master gauge M are fitted.

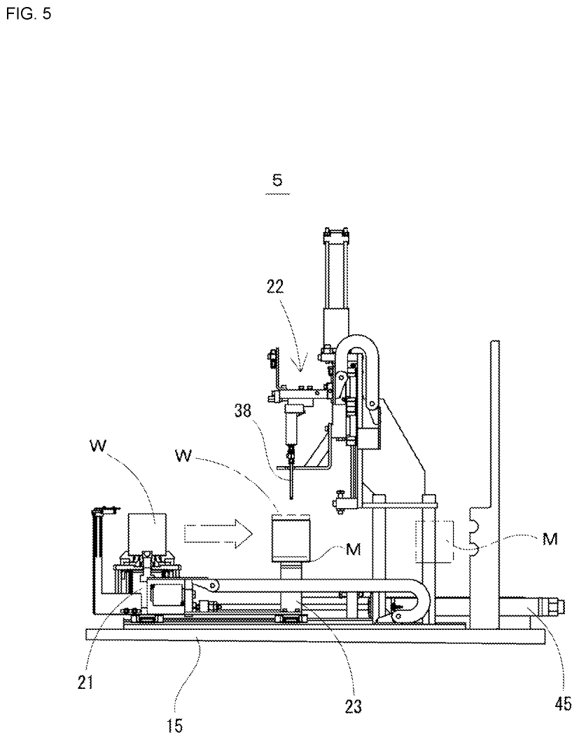

In the position replacing mechanism of inspection device 5, air cylinder 45 is in an extended state at a normal time, and chuck 21 is disposed at the transfer position of workpiece W as illustrated in FIG. 3. On the other hand, when air cylinder 45 is contracted, as indicated by the dashed lines in FIG. 5, workpiece W gripped by chuck 21 is disposed in place of master gauge M at inspection position P. FIG. 5 is a side view of inspection device 5 illustrating the replacement of master gauge M and workpiece W.

Next, operations and effects of inspection device 5 will be described. In inspection device 5, workpiece W processed by front facing twin spindle lathe 1 as described above is carried by autoloader 11. In autoloader 11, robot hand 17 having two chuck mechanisms whose central axes are orthogonal is provided at a tip end of vertical arm 16. Then, inspected workpiece W is picked up from chuck 21 by one robot hand 17, and processed workpiece W gripped by the other robot hand 17 is transferred to empty chuck 21.

Processed workpiece W gripped by chuck 21 in this manner is inspected by inspection machine 22, in which the master alignment is performed in inspection machine 22 in advance. Master gauge M used in inspection device 5 is shaped to match workpiece W (also referred to as a master workpiece), and is set on master table 23 positioned at inspection position P. In the master alignment in inspection machine 22, lifting and lowering slide 35 is lowered by air cylinder 36, so that contactors 38 are positioned at a measurement point having a reference dimension with respect to master gauge M at inspection position P. Then, contactors 38 are brought into contact with the measurement point of master gauge M, whereby the master alignment in inspection machine 22 in which the reference dimension is read is performed.

Inspection machine 22 in which the master alignment is performed is returned to the standby position by lifting and lowering slide 35 by air cylinder 36. Next, when inspecting processed workpiece W, workpiece W and master gauge M are simultaneously moved backward by the same distance by the contraction operation of air cylinder 45, and each of them is disposed at a position indicated by the dashed lines in FIG. 5. With the replacement of inspection position P, processed workpiece W is inspected by inspection machine 22, and thereafter, workpiece W and master gauge M are returned to the position indicated by the solid lines by the extension operation of air cylinder 45.

As a result of the inspection performed on processed workpiece W, when the dimension of the processed portion is within the tolerance range, workpiece W is conveyed to the next step, whereas in a case where the tolerance dimension is deviated, workpiece W is conveyed to a discharge chute (not illustrated) as an NG workpiece and is discarded. While the inspection of processed workpiece W is repeated, in a case where master gauge M is at inspection position P, the master alignment in inspection machine 22 is repeated at any timing.

Therefore, according to the present embodiment, since the master alignment is performed by causing master table 23 to hold master gauge M at all times, the operator is released from the conventional operation in which master gauge M is gripped by and picked up from chuck 21 every time the master alignment. Even if master gauge M is always set in inspection device 5, when inspecting workpiece W, master gauge M deviates from inspection position P, so that it does not disturb the inspection and does not cause the operator to forget to place master gauge M as in the conventional art.

The master alignment with respect to master gauge M and the inspection on workpiece W are always performed at the same inspection position P. Therefore, since the inspection state in inspection machine 22 is constant, inspection device 5 can maintain high inspection accuracy. Further, in the position replacing mechanism of inspection device 5, master table 23 is integrally configured with slide table 41 so that master gauge M and workpiece W can be moved simultaneously, and since guide rail 42, air cylinder 45, and the like are common, the configuration is simplified with a small number of components.

Although one embodiment of the present disclosure has been described, the present disclosure is not limited to the embodiment, and various modifications can be made without departing from the gist thereof. For example, in inspection device 5 of the embodiment, air cylinder 45 is used as an actuator of the position replacing mechanism, but an electric cylinder or the like may be used.

### REFERENCE SIGNS LIST

1: front facing twin spindle lathe, 3: workpiece stocker, 5: inspection device, 11: autoloader, 21: chuck, 22: inspection machine, 23: master table, 38: contactor, 41: slide table, 42: guide rail, 45: air cylinder, 46: slide plate, M: master gauge, P: inspection position, W: workpiece

1. An inspection device comprising:
a chuck configured to grip and release a workpiece;
an inspection machine configured to, by bringing a contactor into contact with a processed portion of the workpiece, inspect the processed portion;
a master table configured to hold a master gauge configured to perform master alignment with respect to the inspection machine; and
a position replacing mechanism configured to integrally move the chuck and the master table and replace the workpiece gripped by the chuck and the master gauge held by the master table with each other at an inspection position in the inspection machine.

2. The inspection device according to claim 1, wherein in the position replacing mechanism, a first slide member on which the chuck is mounted and a second slide member provided with the master table are integrally configured to slide on the same guide rail, and the first slide member is coupled to an actuator configured to perform an extension and contraction operation in a direction parallel to the guide rail.
